(19) United States
(12) Patent Application Publication
(10) Pub. No.: US 2008/0075528 A1
(43) Pub. Date: Mar. 27, 2008

(54) Construction system

(76) Inventor: Michael Marzetta, Spokane Valley, WA (US)

Correspondence Address: WELLS ST. JOHN P.S., 601 W. FIRST AVENUE, SUITE 1300, SPOKANE, WA, 99201, US

(21) Appl. No.: 11/526,264

(22) Filed: Sep. 22, 2006

(51) Int. Cl. B25G 3/00; F16B 9/00

(52) U.S. Cl. 403/238

(57) ABSTRACT

A construction system is described, and which includes a construction element defining a first passageway which extends inwardly relative to the construction element, and a second passageway which extends through the construction element and which intersects with the first passageway; a locking member having an aperture which extends therethrough, and which is received within the second passageway, and is moveable relative thereto; and a fastener body having a coupling member which extends outwardly relative thereto and which is received in the first passageway, and extends, at least in part, through the aperture which is defined by the locking member, and wherein the locking member cooperates with the coupling member to substantially secure the fastener body on the construction element.

### TECHNICAL FIELD

The present invention relates to a construction system, and more specifically to a construction system which includes a plurality of construction elements; and a fastener body and locking member which in combination are particularly useful in constructing toys and hobby crafts of various designs and arrangements.

### BACKGROUND OF THE INVENTION

Children and hobbyists have long enjoyed creative toys which have allowed the individual to construct various items of interest such as boxes, small houses, bridges, airplanes, boats, and the like. Examples of such products have included the Erector™ Set and various Lego™ sets which are provided at various levels of complexity. In the so-called Erector products, these toys have included a series of plates and bars with holes in them which are subsequently joined together with screws and a corresponding nut. Other creative toys have included somewhat similar building units but have further used wooden pegs to join the building units together.

While these prior art products have had a great deal of commercial success, hobbyists and others have continued to request a construction system which permits the hobbyist to build ever increasingly difficult, yet robust, designs but which further is easy to use and can be adapted to various marketplace products which are used in various hobby applications.

A construction system which avoids several of the shortcomings attendant with the prior art devices and practices utilized heretofore is the subject matter of the present application.

### SUMMARY OF THE INVENTION

A first aspect of the present invention relates to a construction system which includes a construction element having an exterior facing surface, and a first passageway which extends inwardly relative to the exterior facing surface of the construction element, and a second passageway which extends through the construction element and which intersects with the first passageway; a locking member having an aperture which extends therethrough, and wherein the locking member is received within the second passageway of the construction element, and is moveable relative thereto; and a fastener body having a coupling member which extends outwardly relative thereto and wherein the coupling member is received in the first passageway, and extends, at least in part, through the aperture which is defined by the locking member, and wherein the locking member cooperates with the coupling member to substantially secure the fastener body on the construction element.

Another aspect of the present invention relates to a construction system which includes a pair of construction elements each having an exterior facing surface, and wherein each of the construction elements defines a first passageway which extends inwardly relative to the exterior surface of the respective construction elements, and wherein the pair of construction elements each further define a second passageway which extends therethrough the respective construction elements, and which further communicates with, and is substantially perpendicularly oriented relative to the first passageway; a pair of locking members each having a main body defined by an exterior facing surface, and which are sized so as be individually received within the respective second passageways as defined by the respective pair of construction elements, and wherein the respective locking members are moveable along a path of travel from a first position, to a second position; and a fastener body having at least two coupling members which extend outwardly therefrom and which are each sized so as to be individually telescopingly received within the respective first passageways which are defined by each of the construction elements, and wherein each of the locking members when located in the first position permit the receipt or the removal of the respective coupling members from each of the first passageways as defined by the respective construction elements, and wherein each of the locking members when located in the second position substantially impedes the removal of the respective coupling members from each of the first passageways as defined by the pair of construction elements.

Still another aspect of the present invention relates to a construction system which includes a first construction element having first and second passageways formed therein, and wherein the first and second passageways communicate with each other and are oriented in substantially perpendicular relation one relative to the other; a second construction element defining a third passageway which extends therethrough; a first locking member having a main body which defines an elongated aperture, and wherein the main body of the first locking member is sized so to be moveably received in the second passageway of the first construction element, and wherein the first locking member is moveable from a first position to a second position; a fastener body having a first end which mounts a coupling member which extends outwardly relative thereto, and an opposite second end, and wherein the coupling member is received in the first passageway of the first construction member and through the aperture defined by the first locking member when the first locking member is in the first position, and wherein the first locking member engages the coupling member, and substantially impedes the removal of the coupling member from the first passageway of the first construction member when the first locking member is in the second position, and wherein the fastener body further defines an internal passageway which extends from the second end of the fastener body in the direction of the first end thereof, and wherein the second end of the fastener body is resiliently deformable, and is received in the third passageway as defined by the second construction element; and a second locking member which is dimensioned for mating receipt, at least in part, within the internal passageway as defined by the fastener body, and wherein the second locking member when received in the internal passageway substantially impedes the removal of the fastener body from the third passageway which is defined by the second construction element.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a perspective, side elevation view which shows certain features of one form of the present invention.

FIG. 2 is a fragmentary, perspective, exploded, side elevation view of the present invention and which shows several features of the present invention.

FIG. 3 is a fragmentary, perspective, end view of one form of a construction element which forms a feature of the present invention.

FIG. 4 is a perspective, side elevation view of one form of a fastener body which forms a feature of the present invention.

FIG. 5 is a fragmentary, perspective, side elevation view of one form of the present invention.

FIG. 6 is a fragmentary, side elevation view of one form of a construction element which forms a feature of the present invention.

FIG. 7 is a perspective, top plan view of a locking member which forms a feature of the present invention.

FIG. 8 is a fragmentary, side elevation view of a second form of a locking member which forms features of the present invention.

FIG. 9 is a fragmentary, perspective, side elevation view of a fastener body and locking member of one form of the present invention in an exploded arrangement so as to illustrate some of the features of the present invention.

FIG. 10 is a fragmentary, perspective, exploded side elevation view of another form of the present invention.

FIG. 11 depicts side elevation views of a plurality of fastener bodies which form features of the present invention.

FIG. 12 is a top plan view of another form of a fastener member having features of the present invention.

FIG. 13 is a perspective, exploded, side elevation view of yet another form of the present invention.

FIG. 14 is a perspective, exploded, side elevation view of still another form of a construction system of the present invention.

FIG. 15 is a greatly enlarged, perspective, side elevation view of another form of a locking member and fastener body having features of the present invention.

FIG. 16 is a greatly enlarged, perspective, side elevation view of one form of a locking member which forms a feature of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

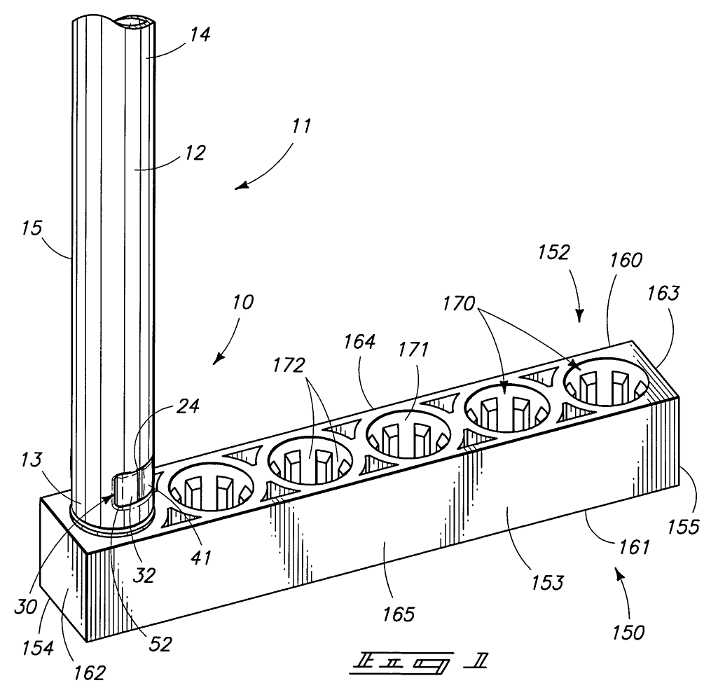

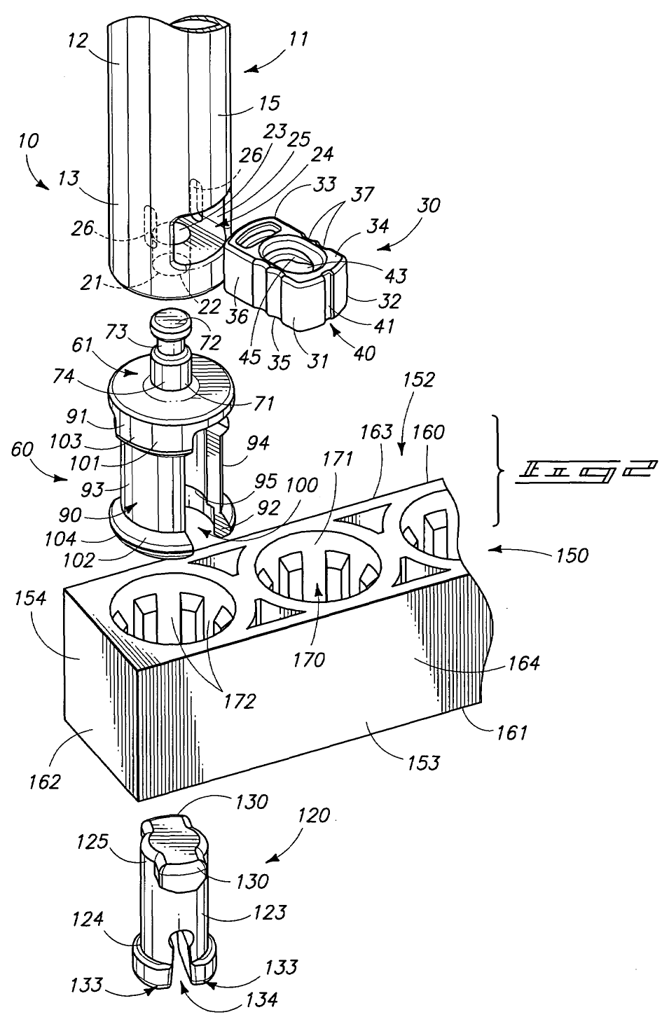

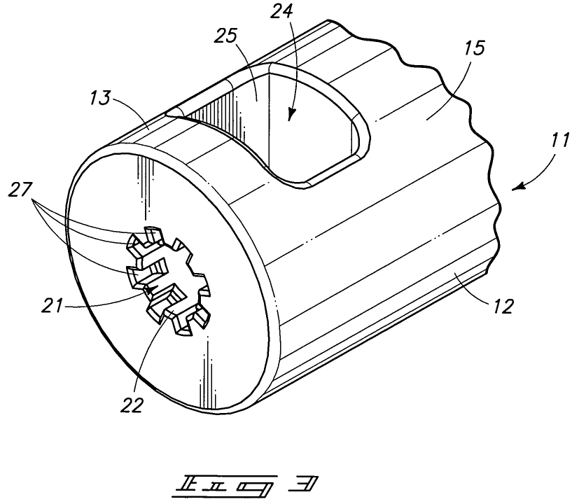

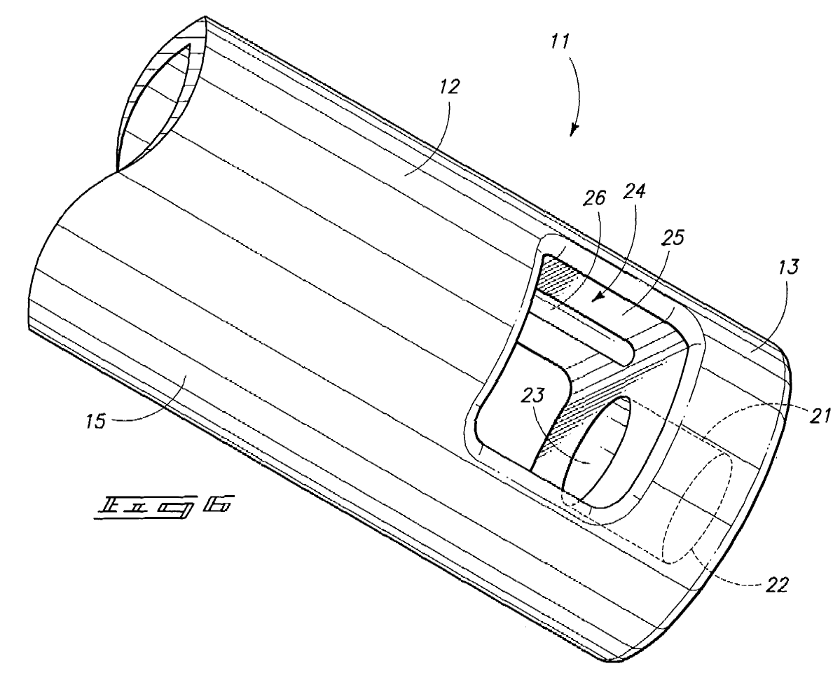

A first form of the construction system of the present invention is generally indicated by the numeral 10 in FIGS. 1 and 2, for example. In this regard, the construction system 10 of the present invention includes a first construction element 11 having a main body 12. The main body has opposite first and second ends 13 and 14, respectively. While the main body 12 of the first construction element 11 is depicted herein as a substantially linear and cylindrically shaped rod, it will be appreciated that the main body may take on a multiplicity of other shapes. These may include, without limitation, linear, curved, and assorted angulated shapes while still not departing from the teachings of the present invention. The main body 12 further defines a first passageway 21 which is formed at the first end 13 of the construction element, and which extends longitudinally inwardly relative thereto. The first passageway has a first end 22 which is located near the first end 13 of the main body 12, and an opposite, second end 23. Still further, a second passageway 24 extends inwardly relative to the exterior surface 15 of the construction element 11 and therethrough the construction element 11. The second passageway 22 intersects with the first passageway 21 at a substantially perpendicular angle. As best seen by reference to FIGS. 2 and 6, the second passageway 24 is defined by a sidewall 25, and at least one detent 26 extends inwardly relative to the second passageway 24 so as to render the second passageway 24 as having a non-uniform or substantially unequal cross sectional dimension. The detent 26 is operable to matingly cooperate with a locking member which will be discussed in greater detail hereinafter. In yet another form of the invention as seen in FIG. 3, the sidewall 25 may define a substantially uniform cross sectional dimension throughout or along its entire length. As seen in FIG. 3, a plurality of keyways 27 may be formed in the exterior surface 15, at the first end 13 of the main body 12, and which are operable to cooperate with an alternative form of a locking member which will also be discussed in greater detail, hereinafter.

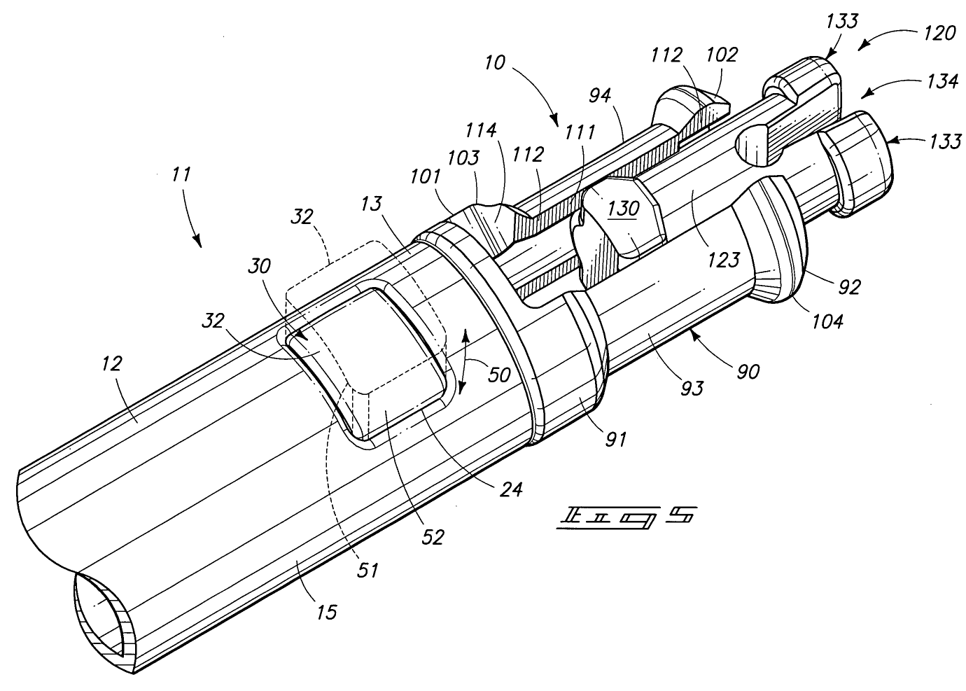

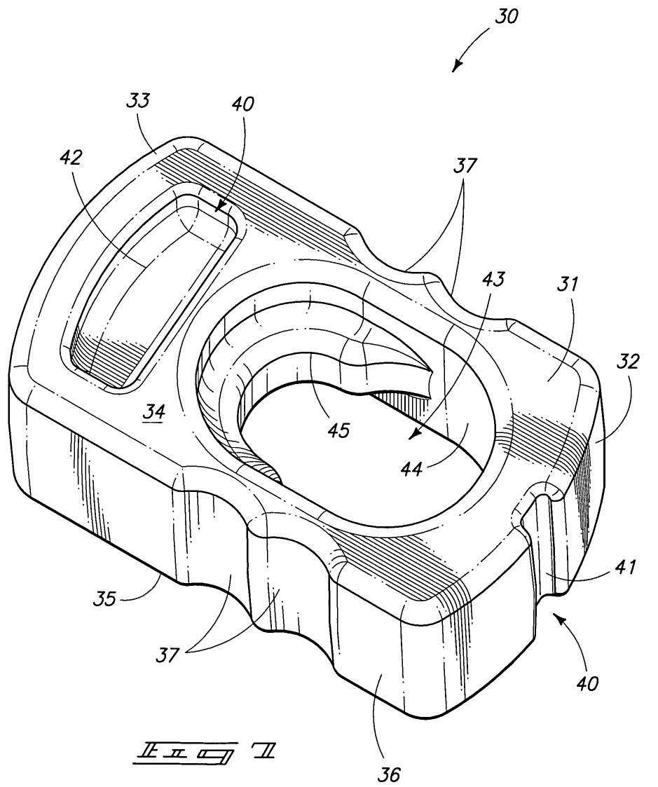

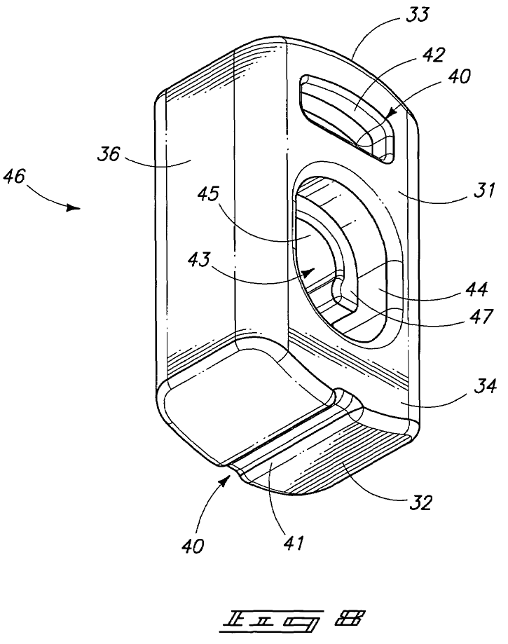

A locking member which finds usefulness in the construction system 10 of the present invention is generally indicated by the numeral 30. In this regard, and referring more specifically to FIG. 7, it will be seen that the locking member 30 includes a main body 31 having a first end 32, and an opposite second end 33. Further, the main body has a top surface 34, and an opposite bottom surface 35. An exterior facing sidewall or surface 36 extends therebetween the top and bottom surfaces and is substantially normal relative thereto. As seen by reference to FIG. 7, opposite pairs of cavities 37 are formed in the sidewall 36, and are located therebetween the first and second ends 32 and 33. These shallow cavities are operable to matingly receive or otherwise cooperate with the earlier mentioned detents 26 which are positioned on the sidewall 25 and which extend inwardly and occlude, at least in part, the second passageway 24. The main body 31 of the locking member 30 is made of a resilient, synthetic material, and the respective detents 26 are operable to move in the manner of a snap-fit from one of the cavities 37, to the other, in order to define a given course of movement for the locking member which will be discussed in greater detail in the paragraphs which follow. As seen in FIG. 7 and in several of the other views, a pair of tool engagement slots 40 are formed in the locking member 30. The tool engagement slots 40 include a first end slot 41 which is formed in the sidewall 36 and which extends between the top and bottom surfaces 34 and 35. This first end slot 41 is operable to receive the tip of a screwdriver (not shown). A user of this invention could insert the screwdriver and thereby exert linear force on the main body 31 to move it along the course of travel which will be described below. Still further, a second, top slot 42, is formed in the top surface 34, and is similarly operable to receive the tip of a screwdriver or other prying tool. Force supplied by a screwdriver or other prying tool will be effective in removing the locking member 30 from the second passageway 24. A substantially elongated or oval aperture 43 extends through the main body 31 from the top surface 34 to the bottom surface 35. The elongated aperture has a non-uniform cross sectional dimension, and is defined by a sidewall 44. Still further, as seen in FIG. 7, an engagement member 45 is mounted on the sidewall 44 and extends inwardly and partially occludes the elongated aperture 43. The engagement member is operable to releasably engage a fastener body which will be discussed in greater detail, hereinafter. An alternative form of the locking member 30 is indicated by the numeral 46 and is seen in FIG. 8. Like numbers refer to like structures. Most notably, and as seen by reference to FIG. 8, it will be recognized that the opposite pairs of cavities 37 are absent from this alternative form of the invention. Still further, it will be noted that the engagement member 45 includes a pair of enlarged ends 47 (only one of which is shown) which is operable to resiliently engage a coupling member in the manner of a snap-fit. The coupling member will be discussed in greater detail hereinafter. Otherwise the locking member 30 generally operates in a substantially similar fashion to that which is seen in FIG. 5.

Referring now to FIGS. 2 and 5, for example, the present construction system 10, and more specifically the locking member 30 is received within the second passageway 24, and cooperates, in one form of the invention, with the detents 26 so as to define a course of travel or path of movement 50. In this regard, the locking member 30 moves between a first position 51, which permits the insertion or removal of a fastener member 60 having a coupling member 61 which is received in the first passageway 21; to a second position 52 which substantially prevents the removal of the coupling member 61 from the first passageway 21. As seen in FIG. 5, it should be appreciated that when the locking member 30 is located in the first position 51, it extends, at least in part, normally outwardly relative to the exterior surface 15 of the construction element 11. Still further, when the locking member 30 is located in the second position 52, it is substantially wholly received within the second passageway 24. The operation of the locking member 30 relative to the coupling member 61, and which is borne by the fastener body 60 will be discussed in greater detail below.

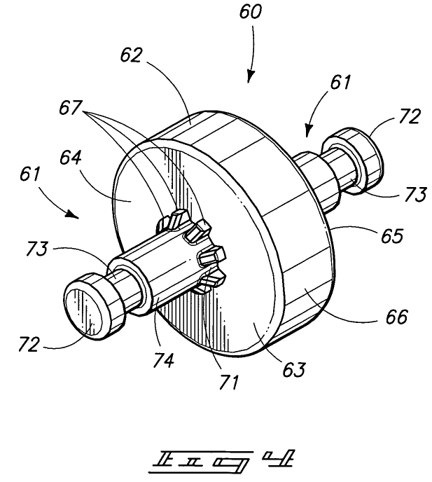

As best understood by a study of the drawings, the present invention 10 includes several alternative forms of the fastener body 60, all of which will be described in greater detail, below. In this regard, and referring to FIGS. 4, 10, 11 and 13, for example, a first form 62 of the fastener body 60 is shown. In each of these multiplicity of forms, the fastener body 60 includes a substantially solid main body 63 which has a first end 64, a second end 65, and a sidewall which is generally indicated by the numeral 66. Referring first to FIG. 4, it will be seen that the first form 62, of the fastener body 60 includes a pair of coupling members 61 which extend normally outwardly relative to the opposite first and second ends 64 and 65. Still further, a plurality of spaced keys are mounted on the first and second ends and extend longitudinally along the respective coupling members 61. These keys are sized so as to be received within the keyways 27 which are formed in the first end 22 of the construction element 11, and which circumscribe the first passageway 21 (FIG. 3). Therefore, the plurality of keys 67, once received in the plurality of keyways 27 are operable to render the main body 63 substantially non-rotatable relative to the first end 13 of the first construction element 11. As will be understood, the coupling member 61 is received within the first passageway 21 and the locking member 30 cooperates with the coupling member 61 to substantially secure the fastener body 60 on the construction element 11.

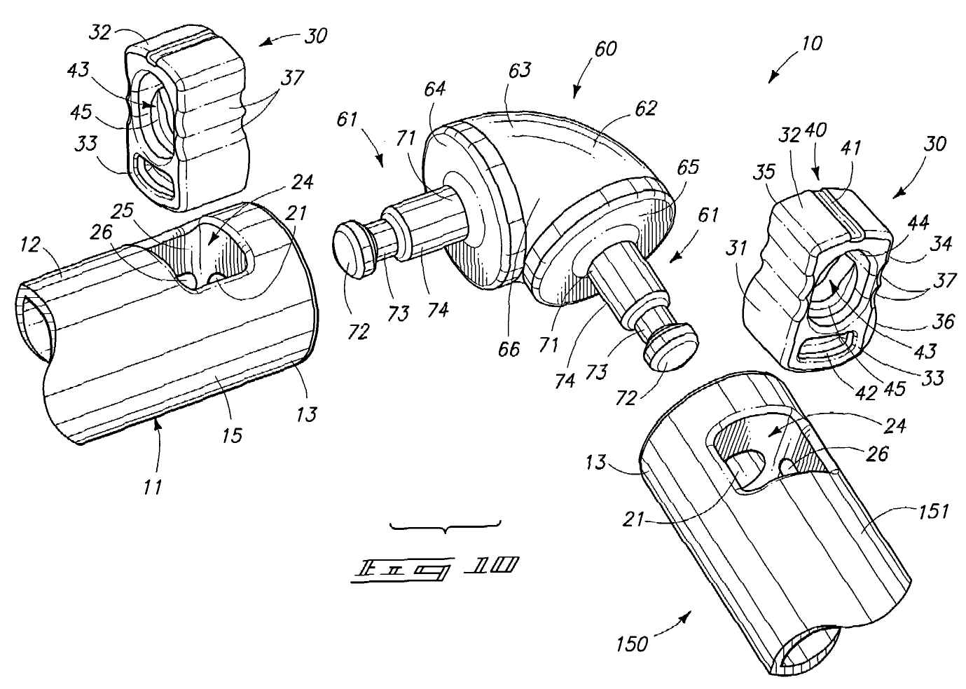

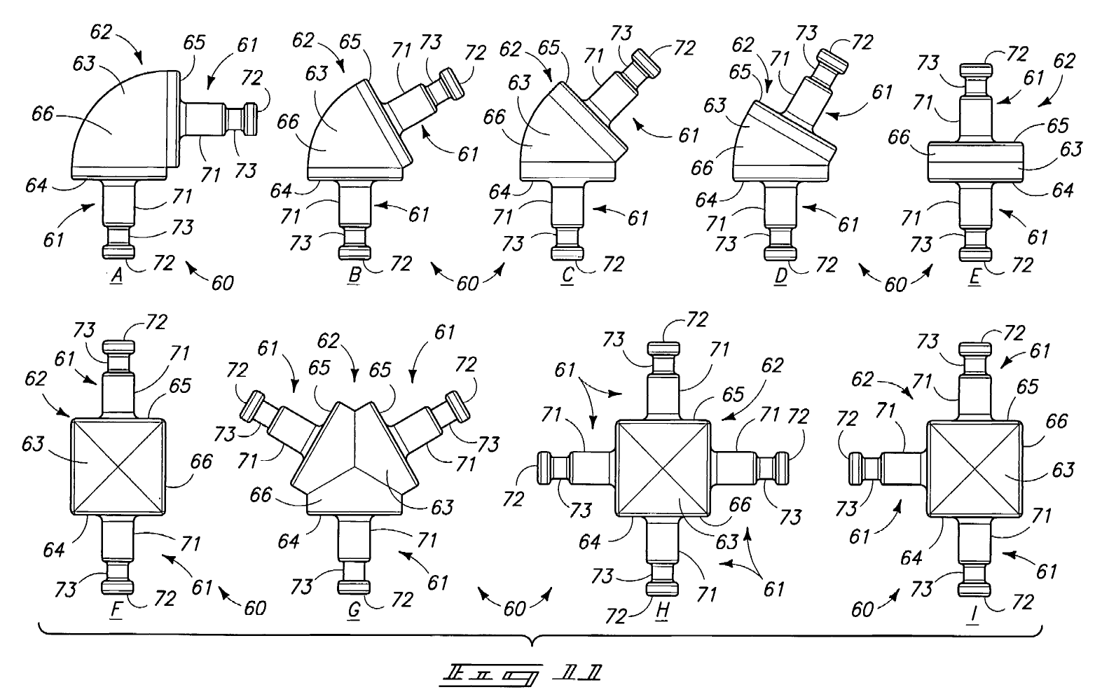

Referring now to FIGS. 10, 11 and 13, it will be seen that the substantially solid main body 63 of the first form 62 of the fastener body 60 may take on a number of different forms. As seen in FIG. 10 for example, it will be seen that the main body 63 may have an elbow or curved shaped main body and wherein the respective coupling members 61 extend substantially normally outwardly from the first and second ends 64 and 65, respectively. Referring now to FIG. 11 where assorted different forms of the fastener body 60 are shown, it will be understood that the main body 63 may place the individual coupling members 61 in various angular orientations, one relative to the other, so as to permit one or several construction elements 11 to be positioned in various orientations, and attached one to another to form various objects of interest. This aspect of the invention will be discussed in greater detail the paragraphs which follow.

As seen in the various drawings, the coupling member 61 has a first end 71 which is affixed to the main body 63, and a second or distal end 72 which is remote thereto. The coupling member 61 is substantially cylindrically shaped, and has an outside diametral dimension which allows it to be telescopingly received within the first passageway 21. As illustrated in the various drawings, a circumscribing channel 73 is formed in the coupling member 61 and is located near the second or distal end 72 thereof. As should be understood, when the coupling member is received within the first passageway 21, the second or distal end thereof 72 is received through the elongated aperture 43 which is formed in the locking member 30 and which had been previously received in the second passageway 24. When the fastener body is in the first position 51, the coupling member may be received within or removed from the elongated aperture 43. Further, when the locking member 30 is moved along the path of travel 50 to the second position 52, the engagement member 45, which is positioned in partially occluding relation relative to the elongated aperture 43, is matingly received within the circumscribing channel 73 and thereby engages the distal end 72 of the coupling member. This mating engagement substantially prevents the coupling member 61, and the accompanying fastener body 60 from being withdrawn from the first passageway 21. Conversely, when the locking member 30 is engaged with a tool, such as a screwdriver and the like, and force is applied to same to move the locking member 30 from the second position 52 to the first position 51, the coupling member 61, the associated fastener body 60 may be withdrawn and separated from the first end 13 of the first construction element 11. Numerous fastener body 60 embodiments are shown. For example, and as seen in FIG. 11, more than two coupling members 61 may extend outwardly therefrom and which are operable to individually cooperate, for example, with a plurality of construction elements 11. In the several forms of the fastener bodies 60 as disclosed herein, many of the embodiments freely rotate relative to the construction element 11. However, and as seen in FIGS. 3 and 4, the fastener body 60 may be rendered substantially non-rotatable by means of the cooperation of the several keyways 27 and keys 67 which are borne by the coupling member 61.

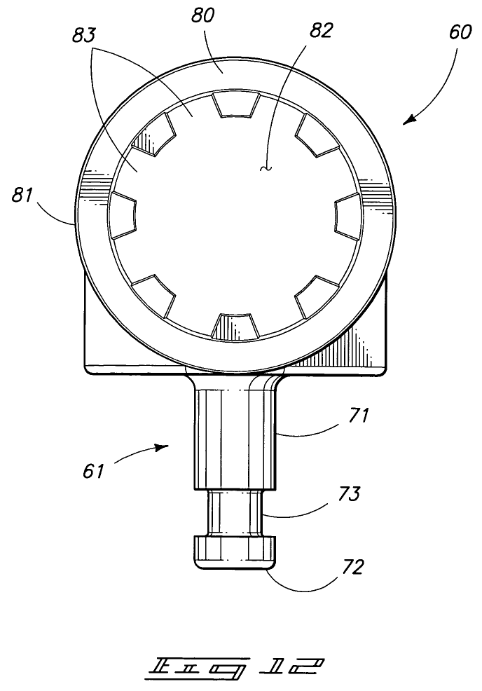

Referring now to FIG. 12, an alternative form of the fastener body 60 is shown. As illustrated in that drawing, the alternative form of the fastener body 60 includes a substantially cylindrically shaped body 81 which has a channel or passageway 82 which extends therethrough. As illustrated in FIG. 12, the channel or passageway is defined by a plurality of spaced orientation grooves 83 and which are operable to slideably receive a portion of yet another alternative form of a fastener body which will be discussed in the paragraphs which follow. Again, in this alternative form of the invention 80, the cylindrically shaped main body 81 is freely rotatable about the first construction element 11 when it is properly engaged by the locking member 30 as earlier described.

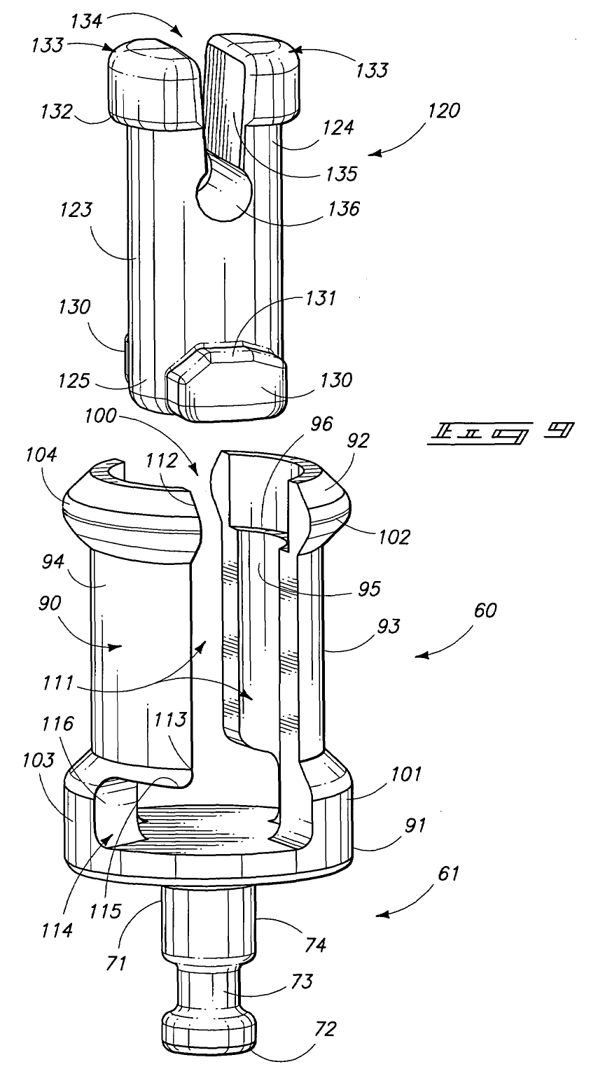

Referring now to FIG. 9, for example, yet another alternative form of the fastener body 60 is shown therein and which is generally designated by the numeral 90. The fastener body 90 has a first end 91, and a resiliently deformable second end 92. Still further, the fastener body 90 has an intermediate portion 93 located between the first and second ends 91 and 92, respectively. Still further, the fastener body 90 has an exterior surface 94, and an opposite interior surface 95 which defines a substantially longitudinally extending internal passageway 100 which extends from the second end of the fastener body 90 in the direction of the first end 91 thereof. As illustrated in FIG. 9 and in several of the other drawings, a first discontinuous circumscribing flange 101 is formed on, and about, the exterior surface 94, and is further positioned near the first end 91 of the fastener body 90. Still further, a second discontinuous and circumscribing flange 102 is located on the exterior surface 94, and is located near the second end 92 thereof. Each of the respective first and second discontinuous and circumscribing flanges 101 and 102 have a circumscribing peripheral edge which is generally indicated by the numerals 103 and 104, respectively, and which further defines an outside diametral dimension for the fastener body 90. As will be recognized from that drawing, the intermediate portion 93 has an outside diametral dimension which is less than the outside diametral dimension of the fastener body 90 as defined by the first and second discontinuous circumscribing flanges 101 and 102, respectively. As will be appreciated from the discussion which follows, and a study of FIG. 2, the fastener body 90 is telescopingly received, at least in part, into a passageway which is defined by a second construction element, and which will be described in greater detail below.

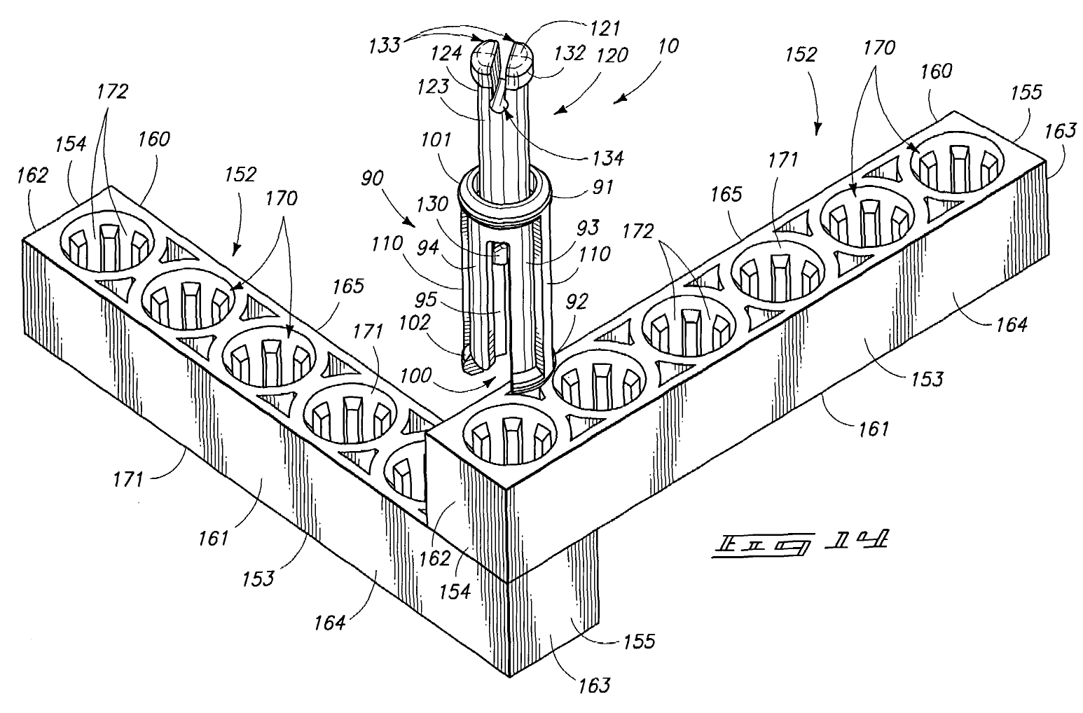

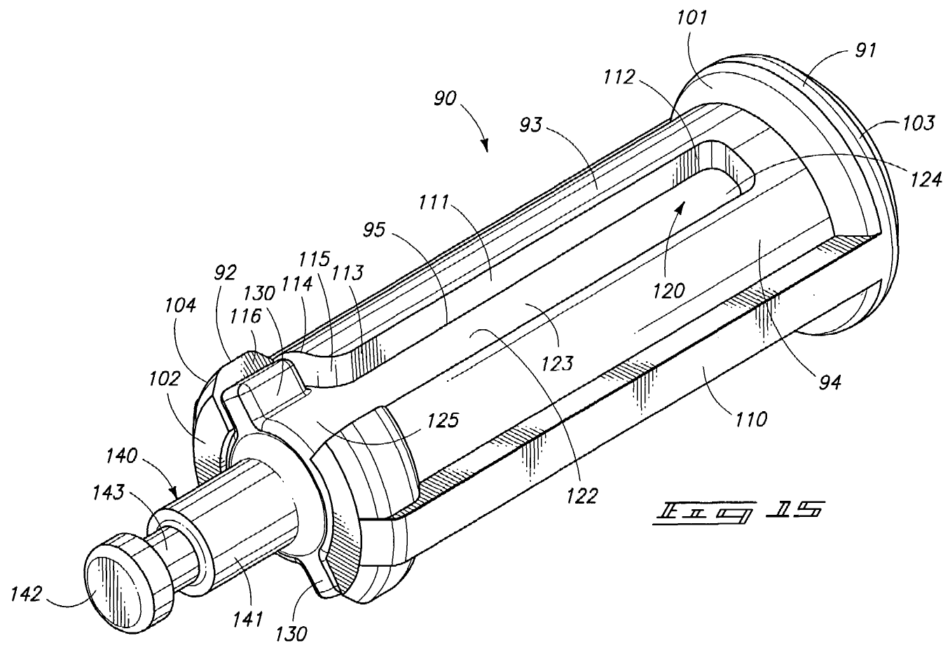

In another form of the invention 10, and as best seen in FIGS. 14 and 15, a tongue or orientation member 110 is mounted on the exterior surface 94 of the fastener body 90 and extends therebetween the first and second discontinuous and circumscribing flanges 101 and 102, respectively. It will be appreciated that more than one tongue or orientation member 110 may be provided. The tongue or orientation members 110 are dimensioned so as to be slideably received within orientation grooves which are defined by a second construction member and which will be discussed below. Referring now to FIG. 15, and in one possible form of the invention, it should be understood that the fastener body 90 may be fabricated from a resilient, thermoplastic, elastomeric, or resilient memory material. When it is fabricated in this fashion, and the tongue or orientation member is received in the respective orientation grooves of the respective construction members, as seen in FIG. 14, the fastener body renders the respective construction members partially resiliently, rotatably, moveable, one relative to the other.

Referring now to FIG. 9, for example, and in one possible form of the invention, the fastener body 90 defines a pair of first guide channels 111 which substantially longitudinally extend from the second end 92 of the fastener body 90 in the direction of the first end 91 thereof. The respective first guide channels 111 communicate with the longitudinally extending internal passageway 100 which is defined by the interior facing surface 95. A circumscribing seat 96 is located near the second end 92. The respective first guide channels have a length dimension which extends substantially along the entire length of the fastener body 90. The pair of first guide channels each have a first end 112, and an opposite second end 113. Still further, the fastener body 90 defines a pair of second guide channels 114 which each communicate with the first guide channels 111, and which further each have a first end 115, and an opposite second end 116. The first and second guide channels are generally perpendicular one relative to the other. As seen, the respective second guide channels are formed substantially within the first circumscribing discontinuous flange 101 (FIG. 9); and the second discontinuous flange as seen in FIG. 15. The width dimensions of the first and second guide channels 111 and 114, respectively, are generally substantially equal. The first and second guide channels 111 and 114 define a course of movement for a second form of a locking member which will be discussed in greater detail hereinafter.

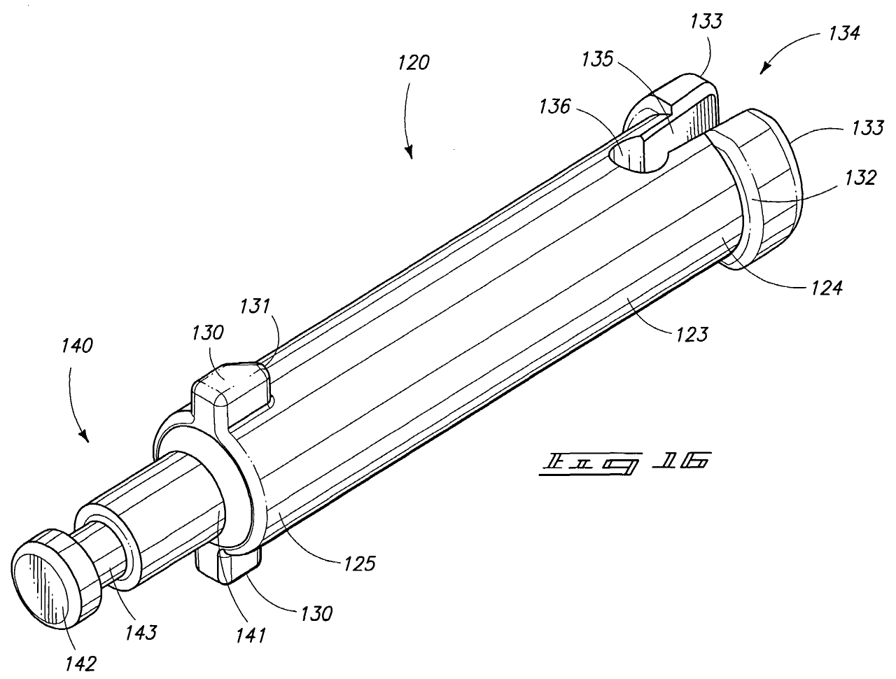

As best understood by reference to FIGS. 2, 9, 14, 15 and 16, for example, the present invention further includes a second form of a locking member, and which is generally indicated by the numeral 120 and which is operable to matingly cooperate with the alternative form of the fastener body 90 that was described above. In this regard, the second form of the locking member 120 is operable, when located in a first position 121, as seen in FIG. 14, allows the fastener body 90 to be telescopingly received, at least in part, within a passageway defined by a second construction element which will be described in greater detail below. Still further, the second form of the locking member 120, when located in a second position 122, as best seen by reference to FIG. 15, substantially impedes the removal of the fastener body 90 from the same passageway. As seen in FIGS. 14 and 15, for example, the second form of the locking member 120 has a main body 123 which is defined by a first end 124, and an opposite second end 125. Still further, the locking member 120 includes a pair of posts which are generally indicated by the numeral 130, and which extend generally normally radially outwardly relative to the second end 125 thereof. The pair of posts have a radial dimension which is less than about the outside diametral dimension of the first or second discontinuous and circumscribing flanges 101 and 102, respectively, and more specifically the circumscribing peripheral edge 103 thereof. Typically, the respective posts 130 when properly cooperating with the fastener body 90 do not extend beyond the exterior facing surface 94 of the fastener body 90. The respective posts 130 each have a top peripheral edge 131 which is operable to matingly cooperate with the second, distal end 116 of the respective second guide channels 114 to releasably secure the locking member 120 in the second position 122. As best appreciated by a study of FIGS. 14, 15 and 16, the locking member 120 includes a circumscribing flange 132 which is positioned about the first end 124 thereof. The circumscribing flange defines a pair of resiliently and radially deformable portions 133. It should be understood, the circumscribing flange defines a peripheral edge defining an outside diametral dimension. The circumscribing flange 132 when seated properly rests thereagainst the circumscribing seat 96 as defined by the interior surface 95 of the fastener body 90 (FIG. 9).

The second form of the locking member 120 defines a tool engagement cavity 134 as best seen by reference to FIG. 9. The tool engagement cavity 134 is formed in the first end 124 and extends in the direction of the second end 125 thereof. The tool engagement cavity 134 has a diminishing dimensioned first portion 135, which is, in turn, coupled to a second portion 136. The tool engagement cavity 134 is operable to receive a corresponding tool as described in my earlier patent application, and which is received in the first and second portions 135 and 136 of the tool engagement cavity 134 in the manner of a snap-fit. The tool, not shown, is operable to impart rotational and linear force and movement to the locking member 120 thereby propelling it along the first and second guide channels 111 and 114, respectively. Extending normally outwardly relative to the second end 125 of the locking member 120 is a coupling member 140 similar to that which was earlier described at 61. The coupling member includes a first end 141, and an opposite second or distal end 142 which is remote thereto. Still further, a circumscribing channel 143 is formed in the second distal end 142 and is spaced therefrom. This channel 143 is operable to cooperate with the first mentioned locking member 30, and more specifically the engagement member 45 thereof in a manner similar to that which was earlier described.

Referring now to FIGS. 2 and 14, for example, the construction system 10 of the present invention further includes a second construction element which is generally indicated by the numeral 150, and which has at least one passageway which extends therethrough, and wherein one fastener body 90 is received in the passageway which is defined by the second construction element, and the coupling member 61, 140 extends outwardly relative to the second construction element 150; and a second locking member 120 is received within the internal passageway 100 which is defined by the fastener body 90 and which substantially impedes the removal of the fastener body 90 from the passageway which is defined by the second construction element 150. Such is understood by a study of FIG. 2, for example. In this regard, the second construction element 150 includes a first form 151 as seen in FIG. 10 and which is substantially identical to the first construction element 11 previously described. Similar numbers define similar structures. Further, the second construction element 150 has a second form 152, as seen in FIGS. 1 and 14 for example. More specifically, the second form 152 of the second construction element 150 has a main body 153 having opposite first and second ends 154 and 155, respectively. Still further, the construction element 152 has a top surface 160, and a bottom surface 161 and first, second, third and fourth sidewalls 162-165, respectively. In the arrangement as seen in FIGS. 1 and 14, for example, the second form of the construction element 152 assumes the shape of a narrowly rectangular block-like member. However, it should be appreciated that the construction element 152 may take on assorted different forms and shapes including cylindrically and other non-rectangular shaped forms as will become apparent from the discussions which follow. For example, one possible arrangement for the shape of the main body may include a block-like member and wherein the main body 153 has an arched or curved form. Additionally, it will be recognized that while the main body 153 is shown having a narrowly rectangular shape, it should be appreciated that the main body may itself assume different configurations such as being formed into a square, curve, round, s-shaped or i-shaped forms depending upon the intended use of the second form of the construction element 150. Therefore, it should be appreciated that the shape as found in FIGS. 1 and 14, for example, is merely illustrative of only one of several possible forms of the second construction element 150 of the present invention. As illustrated in FIGS. 1 and 14, the respective sidewalls 162-165 extend generally normally downwardly relative to the top surface 160. The top and bottom surfaces 160 and 161, respectively, are typically planar, however, in certain forms of the invention the construction element 152 may have a curved or other geometric shapes. In the construction system 10 of the present invention, the second form 152 of the second construction element 150 has at least one passageway 170 formed therein. As seen in the drawings, a plurality of passageways 170 are formed in the main body and extend through the top surface 160 to the bottom surface 161 thereof. While the passageways 170 are shown extending from the top to the bottom surface 160, 161, respectively, it will be appreciated that these same passageways 170 may extend from the third sidewall 164 and through to the fourth sidewall 165.

The several passageways 170 which are formed through the main body 153 has a first maximum inside diametral dimension and a second minimum inside diametral dimension. It should be understood that the second minimum inside diametral dimension of the respective passageways 170 is greater than the outside diametral dimension, for example, of the intermediate portion 93 of the alternative form of the fastener body 90. Further, the first maximum inside diametral dimension is greater than the outside diametral dimensions of the respective discontinuous and circumscribing flanges 101 and 102, respectively. Additionally, the respective passageways 170 each define at least one orientation groove 172 which extends, at least in part, between the opposite sides thereof. As seen in the drawings, a plurality of orientation grooves 172 are formed in a substantially equally spaced pattern about the circumferential edge of the respective passageways 170. These respective orientation grooves 172 each have a width dimension which is slightly greater than the width dimension of the tongue or orientation member 110 which is made integral with the intermediate portion 93 of one form of the fastener body 90. As discussed in my earlier patent application, the tongue or orientation member 110 provides a means by which the fastener body 90 may be rendered immovable, or non-rotatable relative to the second form 152 of the second construction element 150. As best seen in FIG. 14, individual construction elements 152 may be joined together by a fastener body 90 which extends therethrough. In this arrangement, the construction elements 152 are immovable one relative to the other. In contrast, and referring now to FIG. 2, it will be understood that the fastener body 60, once received within the passageway 170 is rotatable relative thereto inasmuch as the fastener body 60 does not include a tongue or orientation member 110 which would be received within the respective orientation grooves 172.

As seen in the drawings, the fastener body 90 defines a channel or passageway 100 which extends from the second end 92 in the direction of the first end 91. The second end of the fastener body 90 defines a discontinuous flange 102 which matingly cooperates with the second form 152 of the second construction element 150. Further, the second form of the locking member 120 has a post 130 which extends normally, radially, outwardly therefrom and which is sized so as to be received within a guide channel 111 and move along same. As will be apparent from the drawings, the second locking member 120 is linearly and partially rotatably moveable relative to the fastener body 90 and wherein the removal of the second locking member from the internal passageway 100 permits the removal of the fastener body 90 from the passageway 170 as defined by the second form 152 of the construction element 150. As seen in the drawings, a tool engagement cavity or slot 134 is formed in the alternative form of the locking member 120 so as to enable a user to impart linear as well as rotatable movement to the locking member 120.

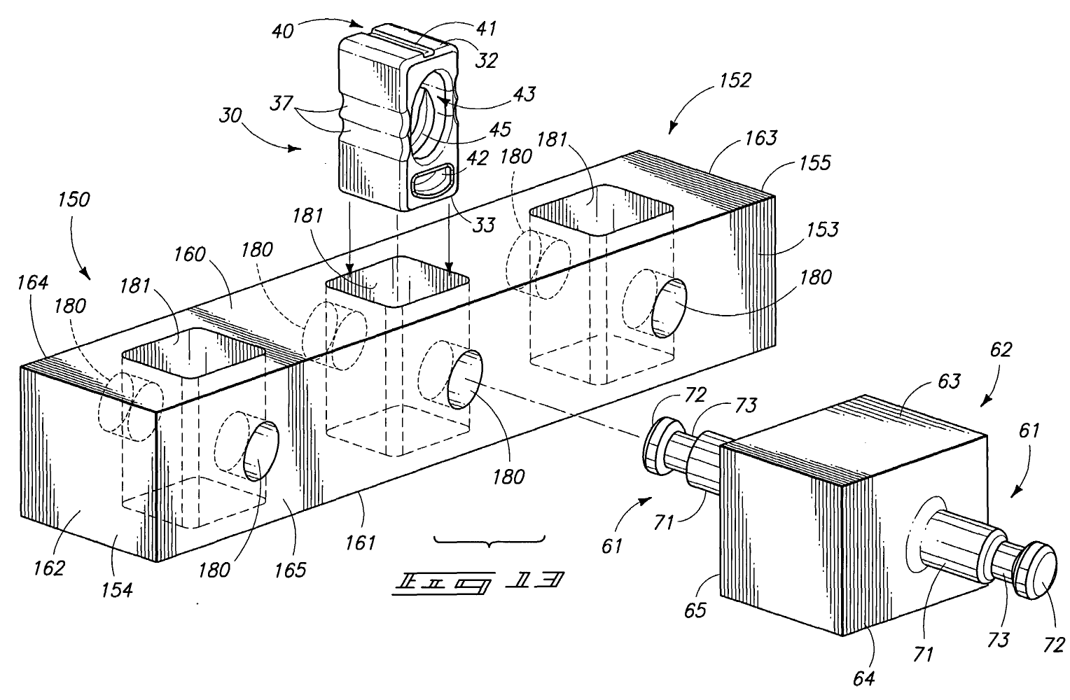

Referring now to FIG. 13, an alternative form of the second construction element 150 is shown. Similar numbers define similar structures. In this particular alternative form of the second construction element 150, it will be seen that the main body 153 has formed therein a plurality of spaced, first passageways 180 which extend through the main body 153. These first passageways 180 have an inside diametral dimension which is greater than the outside diametral dimension of the coupling member 61, 140 which is operable to be telescopingly received within same. Still further, in this alternative form of the construction element 150, a plurality of second passageways 181 are formed therein and which intersect or connect with the respective plurality of first passageways 180. The plurality of second passageways 181 are dimensioned so as to matingly receive the earlier described locking member 30. The locking features and functional attributes of the coupling member 60 remains substantially identical with respect to this alternative form of the construction member 150.

### Operation

The operation of the described embodiment of the present invention is believed to be readily apparent and is briefly summarized at this point.

Referring again to the drawings, a construction system 10 of the present invention includes a construction element 11 having an exterior facing surface 15, and a first passageway 21 which extends inwardly relative to the exterior facing surface 15 of the construction element 11. Still further, the construction element 11 includes a second passageway 24 which extends through the construction element 11 and which intersects with the first passageway 21. The construction system 10 further includes a locking member 30 having an aperture 43 which extends therethrough, and wherein the locking member 30 is received within the second passageway 24 of the construction element 11, and is moveable relative thereto. Still further, the construction system 10 includes a fastener body 60 having a coupling member 61 which extends outwardly relative thereto, and wherein the coupling member is received in the first passageway 21, and extends, at least in part, through the aperture 43 which is defined by the locking member 30. The locking member 30 cooperates with the coupling member 61 so as to substantially secure the fastener body 60 on the construction element 11. In the arrangement as seen in the various drawings, it will be understood that the second passageway 24 is disposed in a substantially perpendicular relationship relative to the first passageway 21. In one possible form of the invention, the second passageway 24 has a non uniform cross sectional dimension (FIG. 6). In another possible form of the invention, the cross sectional dimension of the second passageway 24, 181 is substantially uniform (FIGS. 3 and 13). In one of the forms of the invention 10 (FIG. 6), the second passageway 24 has at least one detent 26 which extends inwardly relative to the second passageway 24 so as to partially occlude the second passageway. In the arrangement as seen in FIG. 6, the detent 26 matingly cooperates with the locking member 30. In the arrangement as seen in FIG. 5, the locking member 30 is moveable along a course of travel 50 from a first position 51 which permits the insertion or removal of the coupling member 61 from the first passageway 21, to a second position 52 which substantially prevents the removal of the coupling member 61 from the first passageway 21. As earlier discussed, the detent 26 matingly cooperates with the locking member 30 so as to define the course of travel 50. In the arrangement as described above, the locking member 30 when located in the first position 51 extends, at least in part, normally outwardly relative to the construction element 11, and further, the locking member when located in the second position 52 is substantially wholly received within the second passageway 24. The locking member 30, as described above, has a main body 31 with an exterior facing surface 36 which is shaped so as to matingly cooperate with the construction element 11, and with the detent 26. The aperture 43 which is defined by the locking member as illustrated is elongated or oval.

In the arrangement as seen in the drawings, the locking member 30 has an engagement member 45 which extends into the aperture 43, and which partially occludes same. As should be understood, the engagement member 45 engages the coupling member 61 when the locking member 30 is in the second position 52 so as to substantially prevent the removal of the coupling member 61 from the first passageway 21. In the arrangement as seen in FIG. 10, the coupling member 61 has a distal end 72 which defines a channel 73, and the engagement member 45 is received in the channel 73 when the locking member 30 is disposed in the second position 52. As best seen by reference to FIG. 11, the fastener body 60 may have a plurality of coupling members 61 which extend outwardly therefrom, and further, the construction element 11 may comprise a plurality of construction elements 11 and 150 which individually cooperate with the respective coupling members. In one form of the invention as seen in FIG. 9, an alternative form of a fastener body 90 is provided and which has a first end 91 and an opposite second end 92 and wherein the coupling member 61 extends outwardly relative to the first end 91. The fastener body 90, in this form of the invention, defines an internal passageway 100 which extends from the second end 92 of the fastener body in the direction of the first end 91 thereof. As earlier discussed, the second end 92 of the fastener body is resiliently deformable. In yet another possible form of the construction system 10 and which is best understood by a study of FIG. 2, for example, a second construction element 150 may be provided and which has at least one passageway 170 which extends therethrough. In this arrangement, the second ends 92 of the fastener body 90 is received in the passageway 170 which is defined by the second construction element 150, and a coupling member 61 extends outwardly relative to the second construction element 150. Still further, a second locking member 120 is provided and which is received within the internal passageway 100 which is defined by the fastener body 90 and which substantially impedes the removal of the fastener body 90 from the passageway 170 which is defined by the second construction element 150. In the arrangement as seen in FIG. 2 and following, the fastener body 90 defines a channel 111 which extends from the second end 92 of the fastener body 90 in the direction of the first end 91, and wherein the second end 92 of the fastener body 90 defines a flange 102 which matingly cooperates with the second construction element 150. Still further, the second locking member 120 further has a post 130 which extends radially outwardly therefrom and which is sized so as to be received within the channel 111 as defined by the fastener body 90 and move along same.

As discussed earlier, the second locking member 120 is linearly and partially rotatably moveable relative to the fastener body 90, and wherein the removal of the second locking member 120 from the internal passageway 100 as defined by the fastener body 90 permits the removal of the fastener body from the passageway 170 as defined by the second construction element 150. In the arrangement as seen in the drawings, a tool engagement slot or channel 134 is formed in the second locking member 120 and the fastener body 90 is rotatable relative to the second construction element 150.

Referring now to FIG. 10, a construction system 10 of the present invention includes a pair of construction elements 11 and 150 each having an exterior facing surface 15 and wherein each of the construction elements define a first passageway 21 which extends inwardly relative to the exterior surface 15 of the respective construction elements. The pair of construction elements 11, 150 each further define a second passageway 24 which extends therethrough the respective construction elements and which further communicates with, and is substantially perpendicular oriented relative to the first passageway 21. The construction system 10 as found in FIG. 10 includes a pair of locking members 30 each having a main body 31 which is defined by an exterior facing surface 36 and which are further sized so as to be individually, moveably received within the second passageways 24 as defined by the respective pair of construction elements 11, 151. The respective locking members 30 are each moveable along a path of travel from a first position 51 to a second position 52. Still further, the construction system 10 includes a fastener body 60 having at least two coupling members 61 which extend outwardly therefrom and which are each sized so as to be individually telescopingly received within the respective first passageways 21 which are defined by each of the construction elements 11 and 151, respectively. Each of the locking members 30, when located in the first position 51 permit the receipt or the removal of the respective coupling members 61 from each of the first passageways 21 as defined by the respective construction elements 11 and 151, respectively. Additionally, each of the locking members 30, when located in the second position 52 substantially impedes the removal of the respective coupling members 61 from each of the first passageways 21 as defined by the pair of construction elements 11 and 151, respectively. As should be understood, the pair of construction elements 11, 151 each have a distal end 14, and the first passageway 21 of the pair of construction elements extends substantially longitudinally inwardly relative to the distal ends thereof. In another form of the invention (FIG. 13), the respective construction elements 150 may each have opposite ends, 154 and 155, and wherein the first passageway 180 of the pair of construction elements is located between the opposite ends thereof. The respective coupling members 61 each have a distal end 72 and wherein each of the locking members 30 releasably engage the distal end of the individual coupling members when the respective locking members 60 are in the second position 52. In one form of the invention, a pair of detents 26 are borne by the respective construction elements 11, 151 and which partially occlude the second passageway 24 thereof. The pair of detents 26 cooperates with the respective locking members 30 so as to releasably secure the respective locking members in the first or second positions 51 and 52. As earlier discussed, the locking members 30 each define an elongated aperture 43 which extends therethrough and the respective coupling members 61 are sized so as to be received, at least in part, through the aperture 43. In the arrangement as seen in FIG. 7, an engaging member 45 is borne by the locking member 30 and further partially occludes the aperture 43. The engagement member 45 engages the distal end 72 of the coupling members 61 when the locking member is in the second position 52. As should be understood, the locking member 30 is resiliently deformable, and has an exterior facing surface 36, and wherein two pairs of cavities 37 are formed in the exterior facing surface of each of locking members 30. These cavities are arranged so as to matingly cooperate with the pair of detents 26 which partially occlude the second passageways 24. These cavities define, at least in part, the path of travel 50 of the locking member 30 between the first and second positions 51 and 52, respectively. As seen by reference to FIG. 11, the fastener body 60 may include three or more coupling members 61.

Referring now to FIG. 2, a construction system 10 of the present invention includes a first construction element 11 having first and second passageways 21 and 24 formed therein, and wherein the first and second passageways communicate with each other and are oriented in substantially perpendicular relation one relative to the other. Still further, a second construction element 150 is provided and which defines a third passageway 170 which extends therethrough. A first locking member 30 is provided and which has a main body 31 which defines an elongated aperture 43. The main body 31 is sized so to be moveably received in the second passageway 24 of the first construction element 11. The first locking member 30 is moveable from a first position 51 to a second position 52 within the second passageway 24. A fastener body 90 is provided and which has a first end 91 which mounts a coupling member 61 which extends outwardly relative thereto, and further has an opposite second end 92. The coupling member 61 is received within the first passageway 21 of the first construction member 11 and through the aperture 43 which is defined by the first locking member 30 when the first locking member is in the first position 51. The first locking member 30 engages the coupling member 61, and substantially impedes the removal of the coupling member from the first passageway of the first construction member when the first locking member 30 is located in the second position 52. The fastener body 90 further defines an internal passageway 100 which extends from the second end 92 of the fastener body in the direction of the first end 91 thereof. The second end 92 of the fastener body is resiliently deformable, and is received in the third passageway 170 as defined by the second construction element 150. The construction system 10 further includes a second locking member 120 which is dimensioned for mating receipt, at least in part, within the internal passageway 100 as defined by the fastener body 90. The second locking member 120 when received in the internal passageway 100 substantially impedes the removal of the fastener body 90 from the third passageway 170 which is defined by the second construction element 150. In the arrangement as seen, the fastener body 90 defines a channel 111 which extends from the second end 92 of the fastener body 90 in the direction of the first end 91. The second end of the fastener body defines a flange 102 which cooperates with the second construction element 150. The second locking member 120 further has a post 130 which extends radially outwardly therefrom and which is sized so as to be received within the channel 111 as defined by the fastener body 90, and move along same. The second locking member 120 is linearly and partially rotatably movable relative to the fastener body 90, and wherein removal of the second locking member 120 from the internal passageway 100 as defined by the fastener body 90 permits the removal of the fastener body from the third passageway 170 as defined by the second construction element 150.

Therefore, it will be seen that the construction system 10 of the present invention is simple in operation and allows a multitude of construction elements to be releasably joined together in a fashion not possible heretofore. The present invention further avoids many of the shortcomings attendant with the prior art practices and other assemblies which have been used for similar purposes.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A construction system, comprising:
a construction element having an exterior facing surface, and a first passageway which extends inwardly relative to the exterior facing surface of the construction element, and a second passageway which extends through the construction element and which intersects with the first passageway;
a locking member having an aperture which extends therethrough, and wherein the locking member is received within the second passageway of the construction element, and is moveable relative thereto; and
a fastener body having a coupling member which extends outwardly relative thereto and wherein the coupling member is received in the first passageway, and extends, at least in part, through the aperture which is defined by the locking member, and wherein the locking member cooperates with the coupling member to substantially secure the fastener body on the construction element.

2. A construction system as claimed in claim 1, and wherein the second passageway is disposed in a substantially perpendicular relationship relative to the first passageway, and wherein the second passageway has a non uniform cross sectional dimension.

3. A construction system as claimed in claim 1, and wherein the second passageway has a substantially uniform cross sectional dimension.

4. A construction system as claimed in claim 2, and wherein at least one detent extends inwardly relative to the second passageway so as to partially occlude the second passageway, and wherein the detent matingly cooperates with the locking member.

5. A construction system as claimed in claim 4, and wherein the locking member is moveable along a course of travel from a first position which permits the insertion or removal of the coupling member from the first passageway, to a second position which substantially prevents the removal of the coupling member from the first passageway, and wherein the detent matingly cooperates with the locking member to define the course of travel.

6. A construction system as claimed in claim 5, and wherein the locking member when located in the first position extends, at least in part, normally outwardly relative to the construction element, and wherein the locking member when located in the second position is substantially wholly received within the second passageway.

7. A construction system as claimed in claim 5, and wherein the locking member has a main body with an exterior facing surface which is shaped so as to matingly cooperate with the construction element and with the detent, and wherein the aperture defined by the locking member is elongated.

8. A construction system as claimed in claim 5, and wherein the locking member has an engagement member which extends into the aperture, and partially occludes same, and wherein the engagement member engages the coupling member when the locking member is in the second position so as to substantially prevent the removal of the coupling member from the first passageway.

9. A construction system as claimed in claim 8, and wherein the coupling member has a distal end which defines a channel, and wherein the engagement member is received in the channel when the locking member is disposed in the second position.

10. A construction system as claimed in claim 1, and wherein the fastener body has a plurality of coupling members which extend outwardly therefrom, and wherein the construction element comprises a plurality of construction elements which individually cooperate with each of the respective coupling members.

11. A construction system as claimed in claim 1, and wherein the fastener body has first end, and an opposite second end, and wherein the coupling member extends outwardly relative to the first end, and wherein the fastener body defines an internal passageway which extends from the second end of the fastener body in the direction of the first end thereof, and wherein the second end of the fastener body is resiliently deformable.

12. A construction system as claimed in claim 11, and further comprising:
a second construction element which has at least one passageway which extends therethrough, and wherein the second end of the fastener body is received in the passageway which is defined by the second construction element, and the coupling member extends outwardly relative to the second construction element; and
a second locking member received within the internal passageway which is defined by the fastener body and which substantially impedes the removal of the fastener body from the passageway which is defined by the second construction element.

13. A construction system as claimed in claim 12, and wherein the fastener body defines a channel which extends from the second end of the fastener body in the direction of the first end, and wherein the second end of the fastener body defines a flange which cooperates with the second construction element, and wherein the second locking member further has a post which extends outwardly therefrom and which is sized so as to be received within the channel as defined by the fastener body, and move along same.

14. A construction system as claimed in claim 13, and wherein the second locking member is linearly and partially rotatably movable relative to the fastener body, and wherein removal of the second locking member from the internal passageway as defined by the fastener body permits the removal of the fastener body from the passageway as defined by the second construction element.

15. A construction system as claimed in claim 13, and wherein a pair of channels are defined by the fastener body, and wherein a pair of posts extend outwardly relative to the second locking member and individually engage the respective channels.

16. A constructions system as claimed in claim 13, and wherein a tool engagement slot is formed in the second locking member, and wherein the fastener body is rotatable relative to the second construction element.

17. A construction system, comprising:
a pair of construction elements each having an exterior facing surface, and wherein each of the construction elements defines a first passageway which extends inwardly relative to the exterior surface of the respective construction elements, and wherein the pair of construction elements each further define a second passageway which extends therethrough the respective construction elements, and which further communicates with, and is substantially perpendicularly oriented relative to the first passageway;
a pair of locking members each having a main body defined by an exterior facing surface, and which are sized so as be individually received within the respective second passageways as defined by the respective pair of construction elements, and wherein the respective locking members are moveable along a path of travel from a first position, to a second position; and
a fastener body having at least two coupling members which extend outwardly therefrom and which are each sized so as to be individually telescopingly received within the respective first passageways which are defined by each of the construction elements, and wherein each of the locking members when located in the first position permit the receipt or the removal of the respective coupling members from each of the first passageways as defined by the respective construction elements, and wherein each of the locking members when located in the second position substantially impedes the removal of the respective coupling members from each of the first passageways as defined by the pair of construction elements.

18. A construction system as claimed in claim 17, and wherein the pair of construction elements each have a distal end, and a longitudinal line of reference, and wherein the first passageway of the pair of construction elements extends longitudinally inwardly relative to the distal end thereof.

19. A construction system as claimed in claim 17, and wherein the pair of construction elements each have opposite ends, and wherein the first passageway of the pair of construction elements is located between the opposite ends thereof.

20. A construction system as claimed in claim 17, and wherein the pair of construction elements each have opposite ends, and wherein the first passageway of one of the pair of construction elements extends inwardly relative to one of the ends of the construction element, and wherein the first passageway of the other of the construction elements is located between the opposite ends thereof.

21. A construction system as claimed in claim 17, and wherein the pair of construction elements freely rotate one relative to the other.

22. A construction system as claimed in claim 17, and wherein the respective coupling members each have a distal end, and wherein each of the locking members releasably engage the distal end of the individual coupling members when the respective locking members are in the second position.

23. A construction system as claim in claim 17, and wherein a pair of detents are borne by the respective construction elements and which partially occlude the second passageway thereof, and wherein the pair of detents cooperate with the respective locking members so as to releasably secure the respective locking members in the first or second positions.

24. A construction system as claimed in claim 17, and wherein the second passageway has a substantially uniform cross sectional dimension.

25. A construction system as claim in claim 22, and wherein each of the locking members defines an elongated aperture which extends therethrough, and wherein the respective coupling members are sized so as to be received, at least in part, through the aperture; and wherein an engagement member is borne by the locking member further partially occlude the aperture, and wherein the engagement member engages the distal end of the respective coupling members when the locking member is in the second position.

26. A construction system as claimed in claim 23, and wherein the locking member is resiliently deformable, and has an exterior facing surface, and wherein two pairs of cavities are formed in the exterior facing surface of each of locking members and which are arranged so as to matingly cooperate with the pair of detents which partially occlude the second passageway and which defines the path of travel of the locking member between the first and second positions.

27. A construction system as claimed in claim 17, and wherein the respective locking members, when located in the first position extend normally outwardly relative to the exterior facing surface of the respective pair of construction elements, and when located in the second position are wholly received within the second passageways of the respective construction elements.

28. A construction system as claimed in claim 17, and wherein the fastener body include three or more coupling members.

29. A construction system, comprising:
a first construction element having first and second passageways formed therein, and wherein the first and second passageways communicate with each other and are oriented in substantially perpendicular relation one relative to the other;
a second construction element defining a third passageway which extends therethrough;
a first locking member having a main body which defines an elongated aperture, and wherein the main body of the first locking member is sized so to be moveably received in the second passageway of the first construction element, and wherein the first locking member is moveable from a first position to a second position;
a fastener body having a first end which mounts a coupling member which extends outwardly relative thereto, and an opposite second end, and wherein the coupling member is received in the first passageway of the first construction member and through the aperture defined by the first locking member when the first locking member is in the first position, and wherein the first locking member engages the coupling member, and substantially impedes the removal of the coupling member from the first passageway of the first construction member when the first locking member is in the second position, and wherein the fastener body further defines an internal passageway which extends from the second end of the fastener body in the direction of the first end thereof, and wherein the second end of the fastener body is resiliently deformable, and is received in the third passageway as defined by the second construction element; and
a second locking member which is dimensioned for mating receipt, at least in part, within the internal passageway as defined by the fastener body, and wherein the second locking member when received in the internal passageway substantially impedes the removal of the fastener body from the third passageway which is defined by the second construction element.

30. A construction system as claimed in claim 29, and wherein the fastener body defines a channel which extends from the second end of the fastener body in the direction of the first end, and wherein the second end of the fastener body defines a flange which cooperates with the second construction element, and wherein the second locking member further has a post which extends outwardly therefrom and which is sized so as to be received within the channel as defined by the fastener body, and move along same.

31. A construction system as claimed in claim 29, and wherein the second locking member is linearly and partially rotatably movable relative to the fastener body, and wherein removal of the second locking member from the internal passageway as defined by the fastener body permits the removal of the fastener body from the third passageway as defined by the second construction element.

32. A construction system as claimed in claim 29, and wherein a pair of channels are defined by the fastener body, and wherein a pair of posts extend outwardly relative to the second locking member and individually engage the respective channels.

33. A constructions system as claimed in claim 29, and wherein a tool engagement slot is formed in the second locking member, and wherein the fastener body is rotatable relative to the second construction element.

34. A construction system, comprising:
a construction element which has at least one passageway which extends therethrough;
a fastener body telescopingly received, at least in part, in the passageway, and which extends, at least in part, outwardly relative to the construction element; and
a locking member cooperating with the fastener body and which, in a first position, allows the fastener body to be telescopingly received, at least in part, within the passageway defined by the construction element, and in a second position, substantially impedes the removal of the fastener body from the passageway defined by the construction element.

35. A construction system as claimed in claim 34, and wherein the fastener body has a first and a second end, and the passageway extends between the first and second ends, and wherein the fastener body is fabricated from a resilient elastomeric material.

36. A construction system as claimed in claim 35, and wherein the fastener body has an exterior facing surface, and wherein at least one tongue is made integral with the exterior facing surface and extends substantially between the first and second ends of the fastener body.

37. A construction system as claimed in claim 36, and wherein the passageway formed in the construction element defines at least one orientation groove which receives the tongue when the fastener body is received in the passageway defined by the construction element.

38. A construction system as claimed in claim 37, and further comprising a second construction element which has a passageway which extends therethrough, and wherein the passageway further defines an orientation groove which receives the tongue, when the fastener body is received in the passageway, and wherein the first mentioned and second construction elements are partially resiliently, rotatably, movable one relative to the other.
